(19) United States
(12) Patent Application Publication
(10) Pub. No.: US 2022/0001820 A1
(43) Pub. Date: Jan. 6, 2022

(54) SNAP-ON AUTOMOTIVE GRILLE OVERLAY AND METHOD FOR MANUFACTURING THE SAME

(71) Applicant: Naje Fattouche, Bowie, MD (US)

(72) Inventor: Naje Fattouche, Bowie, MD (US)

(21) Appl. No.: 16/873,784

(22) Filed: Jul. 2, 2020

(51) Int. Cl. B60R 19/52; B60R 13/04

(52) U.S. Cl. CPC B60R 19/52; B60R 2019/525; B60R 13/04

(57) ABSTRACT

An improved snap-on grille overlay and method for manufacturing the same, comprising interior regions containing the snap-on technology used for snapping over corresponding exterior regions of a manufacturer's existing grille, wherein upon engagement of a rigid polymer upper lip and a rigid polymer lower lip and a rigid polymer connecting lip of the present invention's improved automotive grille overlay with the corresponding portions of a manufacturer's grille, the present invention's improved automotive grille overlay is firmly affixed to said manufacturer's grille without the use of double-sided tape or clips as taught by the prior art. In addition, a three dimensional (3D) scanned imaging of the individual embodiment component parts is generated, after rigorous testing, and is transferred to an injection molding computer to generate the injection molding designed precisely corresponding to each individual component parts of the present invention.

### TECHNICAL FIELD

The presently disclosed subject matter generally pertains to an automotive grille overlay, and more specifically to an automotive grille overlay capable of snapping over an identical, previously installed automotive grille of an automobile. The purpose of the formerly described automobile grille overlay is to cover up the latterly described manufacturer's automobile grille which was damaged, for example, during an automobile collision, or in the absence of an automobile collision but in the presence of other non-collision damage so as, to provide a span-on automobile grille overlay of the present invention with an enhanced cosmetic finish and an attractive appearance.

### BACKGROUND

In general, after-market components are used to enhance automobile cosmetic appearances which can be added to an automobile to add decoration and customization to a vehicle beyond what is supplied by the vehicle manufacturer. One component is an automobile grille overlay which fits over the manufacturer's installed automobile grille and provides a customized look. An after-market automobile grille overlay is typically custom manufactured to precisely fit over a specific one or more grille of a specific vehicle or vehicles. Commonly, after-market automobile grille overlays are finished in a chrome or black finish, thus providing a new look to the automobile installed thereon.

After-market automobile grille overlays are comprised of different shapes and designs and are used to fit over automobile factory grilles when said grilles are damaged, for example, in an automobile collision or when said grilles demonstrate severe wear and tear and are unattractive due to being exposed to the environmental elements for a significant amount of time. When installed, the grille overlays cover the damaged grilles and provide the automobiles with new cosmetic and new decorative finishes which enhance said automobiles' appearances and increase their resale value.

Most automobile grilles which are known in the prior art are typically designed to replace the damaged manufacturer's grilles. Replacing the manufacturer's grille requires expending significant resources on labor needed to first remove the manufacturer's grille and second to replace the manufacturer's grille with the replacement after-market grille. Next the replacement grille is painted, which blends the grille with the appearance of the rest of the vehicle.

Prior to 2006, the prior art taught automobile grilles and method of manufacturing said grilles were used to outright replace manufacturers' grille when damaged, for example, during a automobile collision, or when damaged, for example, during long exposure to the environmental elements. Nunes in U.S. Pat. No. 7,073,849 describes these pre-2006 prior art automobile grilles used as outright replacement for damaged grilles whether said damage was caused by an automobile collision or by environmental degradation, and the manner in which they were manufactured or constructed.

First, Nunes in U.S. Pat. No. 7,073,849 describes Chase in U.S. Pat. No. 5,487,575 as teaching an automobile grille capable of withstanding a frontal collision impact which is chromium plated so as to promote flexural property of the automobile grille. Second, Nunes, in U.S. Pat. No. 7,073,849 describes Flewitt et al. in U.S. Pat. No. 6,027,150 as teaching an automobile radiator grille assembly comprising an upper edge that edges the hood of a vehicle and a lower edge that engages the bumper of a vehicle. According to Nunes, Flewitt et al. further teaches that resilient arms are used to secure the upper portion of the replaced automobile grille to the vehicle, and resilient means are used to bias the upper edge of the grille to the hood. Third, Nunes in U.S. Pat. No. 7,073,849 describes Stull in U.S. Pat. No. 6,702,343 as teaching a grille manufactured from aluminum and later power coated. Stull describes attaching to the leading edge of the grille multiple steel strips for reducing moisture within the coating and improving the decorative appearance of the grille.

Post 2006, Nunes in U.S. Pat. No. 7,073,849, for its part teaches a snap-on chrome plated automotive grille overlay. Specifically, Nunes teaches a snap-on technology needing vertical and horizontal bars or slats configured to duplicate an existing automotive grille when nested thereupon. According to Nunes, the overlay grille is having protruding clips integrally formed on said grille overlay. Nunes further teaches said clips having a bevel on an interior surface allowing for deflection over the automotive grille, thereby permitting the grille overlay to be snapped into place.

Post Nunes, Doroghazi et al. in U.S Patent Application Publication 2009/0066096 A1 teaches a vehicle grille including structural inner member and decorative outer member with snap-in features. It is important to note that Doroghazi et al. does not teach an overlay snap automotive grille. Doroghazi et al. teaches a grille comprising an outer member and an inner member. Said outer member including a plurality of molded-in snap features to engage with the inner member at a plurality of corresponding snap-receiving points or locations. The snap-in technology described by Doroghazi et al. is a lower tensioning foot comprising a part that hooks around another specified part and includes a retaining portion that is generally perpendicular to the ground, which rocks into position and helps hold the grille in place.

Rosen et al. in U.S. Pat. No. 7,537,253 teaches a method for attaching a polished metal grille surround. Rosen et al. teaches a shell formed from metal sheet and a backing structure wherein the backing structure is fixedly secured to the shell and the backing structure is fixedly secured to the vehicle. That the shell and the backing structure are held together by an adhesive and by inserting a threaded insert into a corresponding aperture. Another prior art Lee in U.S. Patent Application Publication 2017/0021786 teaches a multi-piece vehicle shield assembled by studs and apertures having snap-together feature.

Other than Nunes or U.S. Pat. No. 7,073,849, no other prior art teaches a snap-on grille overlay. However, Nunes differs from the present invention in several ways. First, due to the limitations of Nunes' snap-on technology, Nunes' automotive grille overlay is capable of fitting only a manufacturer's automotive grille comprising one or more horizontal slats and one or more vertical bars that are formed within a thin-walled overlay body. In contrast, the present invention's snap-on technology allows for installing an automotive grille overlay capable of fitting all shapes and styles in the present day market place.

Second, Nunes' snap-on technology teaches a plurality of inward-protruding clips integrally formed within the slats and bars for connecting the grille to the vehicle. In additional to further support the plurality of inward-protruding clips and to prevent vibration from separating the overlay from the vehicle grille and to minimize noise levels, a cushioning material may be attached to an inside surface of the thin-walled grille overlay body. In contrast, the present invention teaches manufacturing and installing a snap-on technology within an interior region of a horizontal slat of an automotive grille overlay, teaches manufacturing and installing a snap on technology of the present invention within an interior region of a vertical bar of an automotive grille overlay, teaches manufacturing and installing a snap on technology of the present invention within an interior region of a parabolic bar of an automotive grille overlay, and teaches manufacturing and installing a snap-on technology of the present invention within an interior region of a polygon-based, interlocking mesh system of an automotive grille overlay.

The present invention does not require the use of protruding clips or cushioning material or the use of adhesive tapes to prevent vibration from separating the grille overlay from a vehicle's original grille or to minimize noise levels when a vehicle is in motion. Thus, the prior art automotive grille overlays require the application of secondary components for affixing to the original manufacturer's automotive grilles (i.e. tape, glue, clips, etc.). This makes installation somewhat tedious, inconvenient, expansive and perhaps even messy. Furthermore, these prior art automotive grille overlays are prone to loosen over time with repeated use of the automobile, and requiring numerous, labor intensive and costly repairs over the life span of the automobile.

### General Description

A primary objective of the present invention is to provide an improved automotive grille overlay that has the identical configuration of a damaged manufacturer's automotive grille capable of being securely snapped on into place over the latter, and providing the appearance of a new or enhance manufacturer's automotive grille without the need of removing the damaged automotive grille.

Another objective of the present invention is to provide an improved automotive grille overlay capable of being snapped-on to an existing manufacturer's automotive grille, without requiring the use of double-sided tape or other bonding materials, or clips, to hold the automotive grille overlay in place.

Another objective of the present invention is to provide an improved automotive grille overlay constructed of rigid material capable of being flexed and optionally constructed of a single piece of polymer material capable of affixing over an existing manufacturer's automotive grille without any additional components.

Still another objective of the present invention is to provide an improved automotive grille overlay capable of being snapped over a manufacturer's grille to cover up damage or wear and tear of the latter without being noticeable to consumers that said improved automotive grille overlay had been installed.

Yet another objective of the present invention is to provide an improved automotive grille overlay capable of being snapped over a manufacturer's grille to cover up damage or wear and tear of the latter without requiring numerous, labor intensive and costly repairs over the life span of the automobile.

In accordance with certain aspects of the presently disclosed subject matter, there is provided an improved automotive grille overlay capable of being snapped over a manufacturer's existing grille to cover up damage or wear and tear of the latter, said improved automotive grille overlay comprising horizontal slats, vertical bars and/or polygon-based interlocking mesh system with interior regions used for snapping over corresponding regions of a manufacturer's existing grille in need of repair or appearance enhancement.

In accordance with further aspects and, optionally, in combination with other aspects of the presently disclosed subject matter, the interior regions of the present invention's improved automotive grille overlay containing the snap-on technology used for snapping over corresponding regions of a manufacturer's existing grille is comprised of a rigid polymer upper lip protruding continuously along a rigid polymer upper longitudinal edge and a rigid polymer upper arm edge which is capable of having a curved shape, an oval shape, a parabolic shape, a linear shape or having a polygon shape with respect to the upper longitudinal edge, and a rigid polymer lower lip protruding continuously along a rigid polymer lower longitudinal edge and a rigid polymer lower arm edge which is capable of having a curved shape, an oval shape, a linear shape or having a polygon shape with respect to the lower longitudinal edge.

In accordance with further aspects and, optionally, in combination with other aspects of the presently disclose subject matter, the interior regions of the present invention's improved automotive grille overlay containing the snap-on technology used for snapping, over corresponding regions of a manufacturer's existing grille is comprised of an upper rigid polymer hook-shaped member that protrudes along the entire upper lip and defines an interior region which grippingly engages an upper portion of an existing manufacturer's grille, and a lower rigid polymer hook-shaped member that protrudes along the entire lower lip and defines an interior region which grippingly engages a lower portion of an existing manufacturer's grille.

Still, in accordance with further aspects and, optionally, in combination with other aspects of the presently disclose subject matter, the interior regions of the present invention's improved automotive grille overlay containing the snap-on technology is used for snapping over corresponding regions of a manufacturer's existing grille, wherein upon engagement of said rigid polymer upper lip and said rigid polymer lower lip of the present invention's improved automotive grille overlay with the corresponding portions of a manufacturer's grille, the present invention's improved automotive grille overlay is firmly affixed to said manufacturer's grille.

Still, in accordance with further aspects and, optionally, in combination with other aspects of the presently disclosed subject matter, a rear surface of said automotive grille overlay of the present invention is contoured to precisely conform to the visible surface of an existing manufacturer's grille such that upon engagement of the upper lip and lower lip on said manufacturer's automotive grille, said improved automotive grille overlay of the present invention is intended to be flush against the manufacturer's automotive grille.

Still, in accordance with further aspects and, optionally, in combination with other aspects of the presently disclosed subject matter, the horizontal slats, the vertical bars, the parabolic bars and the interlocking parabolic mesh system, etc. of the improved automotive grille overlay of the present invention may be composed of a rigid polymer material that can be temporarily flexed during installation of said automotive grille overlay over an existing manufacturer's grille.

Yet, in accordance with further aspects and, optionally, in combination with other aspects of the presently disclosed subject matter, the horizontal slats, the vertical bars, the parabolic bars and the interlocking parabolic mesh system, etc. are manufactured from a rigid material that allows for manipulation of the panels and interlocking system during installation over an existing manufacturer's automotive grille to facilitate engagement of the upper lip and lower lip of the snap-on technology of the present invention with the upper portion and lower portion of the existing manufacturer's grille respectively.

Yet still, in accordance with further aspects and, optionally, in combination with other aspects of the presently disclosed subject matter, the front surface of the improved automotive grille overlay of the present invention is finished in a decorative finish.

Among advantages of certain embodiments of the presently disclosed subject matter is that the improved automotive grille overlay of the present invention can be snapped on to an existing manufacturer's existing grille and held firmly in place by means of the upper lip and lower lip of the improved automotive grille overlay of the present invention without requiring the use of double sided tape or clips to hold the automotive grille overlay in place.

### BRIEF DESCRIPTION OF THE DRAWINGS

In order to understand the invention and to see how it can be carried out in practice, embodiments will be described, by the way of non-limiting examples, with references to accompanying drawings, in which:

FIG. 1A illustrates a front elevated perspective view of the improved snap-on automotive grille overlay of the present invention prior to snap-on installation, and having parabolic bars and a polygon-based interlocking mesh system.

FIG. 1B illustrates a front elevated perspective view of the improved snap-on automotive grille overlay of the present invention post snap-on installation, and having a parabolic bar and a polygon-based interlocking mesh system.

FIG. 2A illustrates a front elevated perspective view of the improved snap-on automotive grille overlay of the present invention prior to snap-on installation, and having horizontal slats and vertical bars interlocking system.

FIG. 2B illustrates a front elevated perspective view of the improved snap-on automotive grille overlay of the present invention post snap-on installation, and having horizontal slats and vertical bars interlocking system.

FIG. 3A illustrates a front elevated perspective view of the improved snap-on automotive grille overlay of the present invention prior to snap-on installation, and having horizontal slats and peripheral-hexagonal members with parabolic openings.

FIG. 3B illustrates a front elevated perspective view of the improved snap-on automotive grille overlay of the present invention post snap-on installation, and having horizontal slats and peripheral-hexagonal members with parabolic openings.

FIG. 4 illustrates a rear elevated perspective view of the improved snap-on automotive grille overlay of the present invention having horizontal slats and peripheral-hexagonal members with parabolic and configuration of clips.

FIG. 5A illustrates a rear elevation view of the improved snap-on automotive grille overlay of the present invention having a parabolic peripheral border with horizontal slats and grooves for positioning clips.

FIG. 5B illustrates a cross-sectional view taken along a section of FIG. 5A illustrating interior regions containing the snap-on technology of the present invention.

FIG. 5C illustrates a cross-sectional view taken along a section of FIG. 5A illustrating interior regions containing of the snap-on technology of the present invention.

FIG. 6A illustrates a rear elevated perspective view of the improved snap-on automotive grille overlay of the present invention having an inner parabolic bar and an outer peripheral parabolic bar and a polygon-based interlocking mesh system.

FIG. 6B illustrates a cross-sectional view taken along a section of FIG. 6A illustrating interior regions containing the snap-on technology of the present invention.

FIG. 6C illustrates a cross-sectional view taken along a section of FIG. 6A illustrating interior regions containing the snap-on technology of the present invention.

FIG. 7A illustrates a rear elevated perspective view of the improved snap on automotive grille overlay of the present invention having horizontal slats, peripheral-hexagonal members with parabolic openings, and interior region containing snap-on technology of the present invention.

FIG. 7B illustrates a cross-sectional view taken along a section of FIG. 7A illustrating interior regions containing the snap-on technology of the present invention.

FIG. 7C illustrates a cross-sectional view taken along a section of FIG. 7C illustrating a polymer hook-shaped member of the snap-on technology of the present invention.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, and components have not been described in detail so as not to obscure the presently disclosed subject matter.

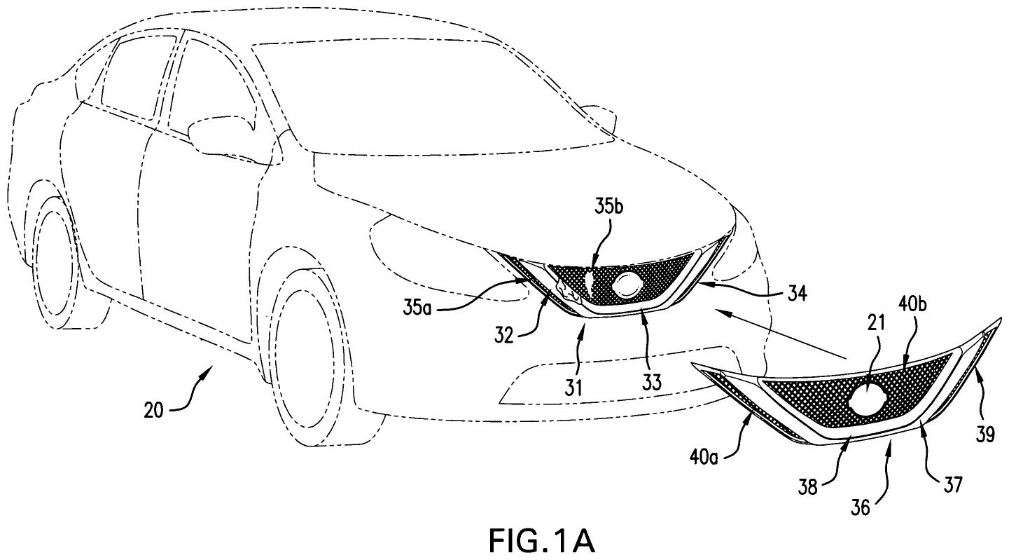

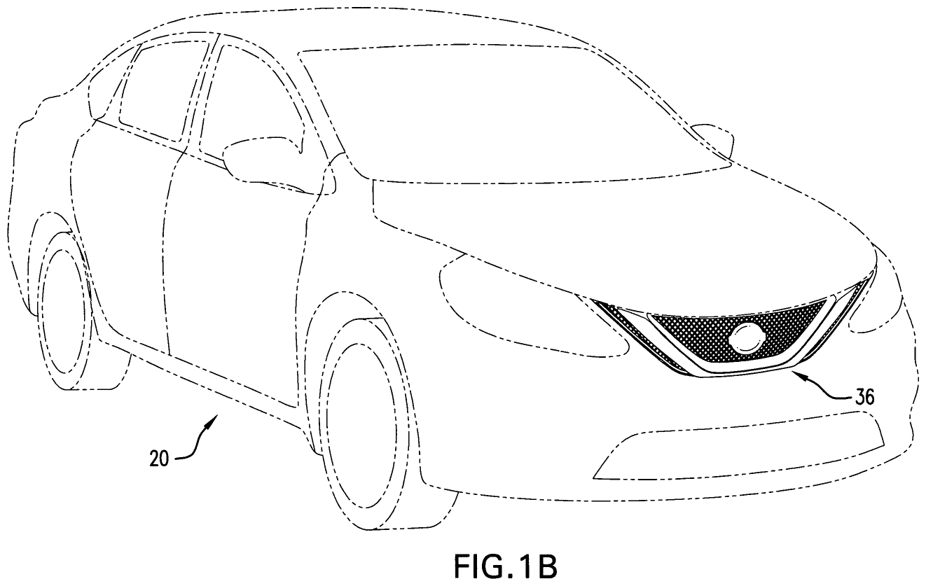

Bearing in mind, attention is drawn to FIGS. 1A and 1B illustrating an improved snap-on automotive grille overlay of the present invention prior to installation and after installation respectively. Said improved snap-on automotive grille is used for covering over a damaged manufacturer's grille resulting from an automobile accident or resulting from environmental wear and tear and without requiring numerous, labor intensive and costly repairs over the life span of the automobile.

As shown in FIG. 1A, an automobile 20 with a damaged manufacturer's grille 31 comprises a damaged, larger-outer parabolic bar 32, a small-inner parabolic bar 33, an outer peripheral parabolic bar 34, a minor, undamaged and polygon-based interlocking mesh system 35a, and a major, damaged and polygon-based interlocking mesh system 35b. Still referring to FIG. 1A, an identical pre-installed automotive grille overlay of the present invention 36 comprises an undamaged, larger-outer parabolic bar 37, an undamaged, smaller-inner parabolic bar 38, a peripheral boundary member 39, a minor, undamaged and polygon-based interlocking mesh system 40a, a major, undamaged and polygon-based interlocking mesh system 40b and an opening 21. Therefore, as shown in FIG. 1B, an improved automotive grille overlay 36 of the present invention with identical configuration of a damaged manufacturer's automotive grille 31 is securely snapped on into place over the former, thereby providing the appearance of a new or enhanced manufacturer's automotive grille, without the need of removing said damaged manufacturer's automotive grille 31.

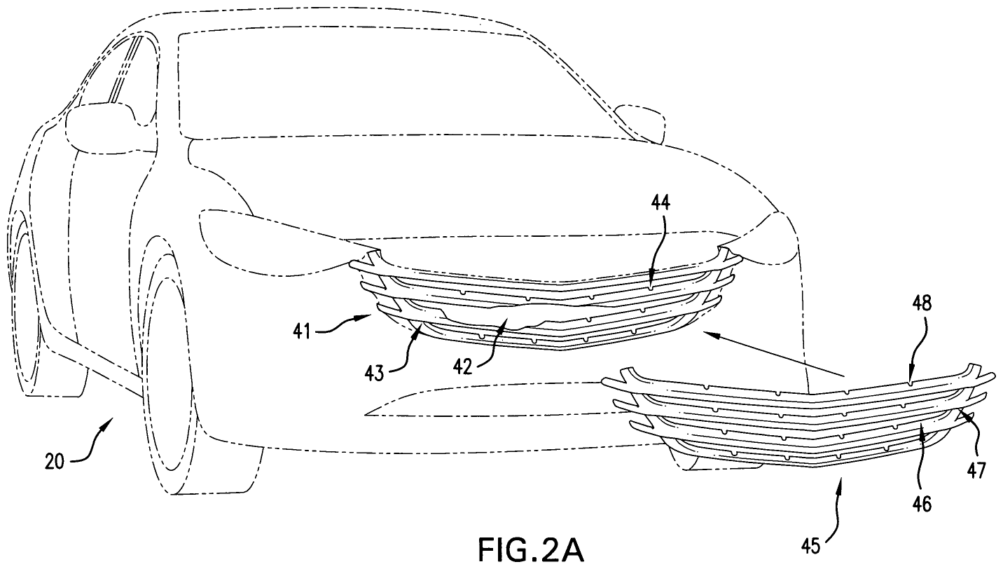

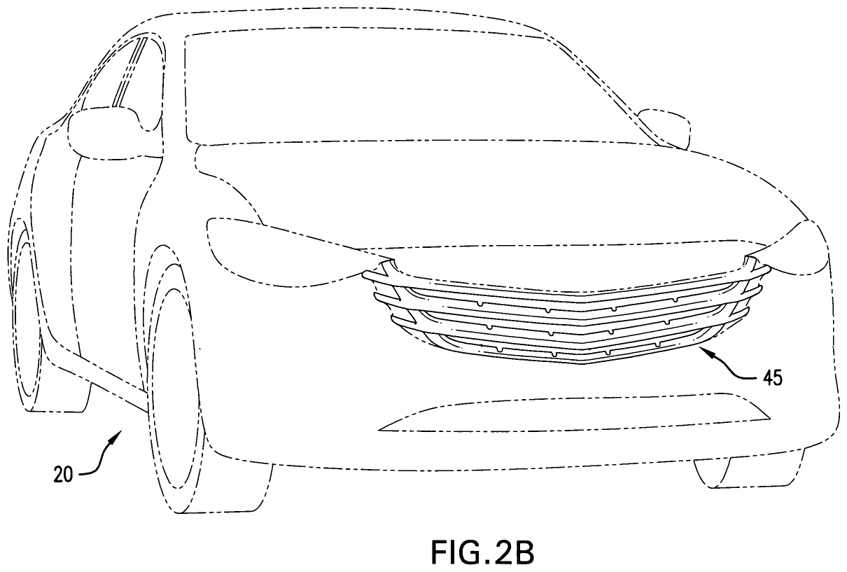

Again referring to the embodiment of this present invention, FIG. 2A illustrates an automobile 20 with a damaged manufacturer's grille 41 which comprises a damaged inner horizontal slat 42, an outer peripheral-vertical parabolic bar 43 and a sample groove 44 used for attaching said manufacturer's grille to the frame of an automobile with clips or other fasteners, etc. Still referring to FIG. 2A, a pre-installed automotive grille overlay of the present invention 45 comprises multiple, undamaged horizontal slats wherein one slat is represented as 46, an outer peripheral-vertical parabolic bar 47 and a sample groove 48 used for attaching said grille of the present invention to the frame of an automobile with clips or other fasteners, etc. As shown in FIG. 2B, an automotive grille overlay 45 of the present invention with identical configuration of said damaged manufacturer's automotive grille 41 is securely snapped on into place over the latter, thereby providing the appearance of a new or enhance manufacturer's automotive grille without the need of removing said damaged manufacturer's automotive grille 41.

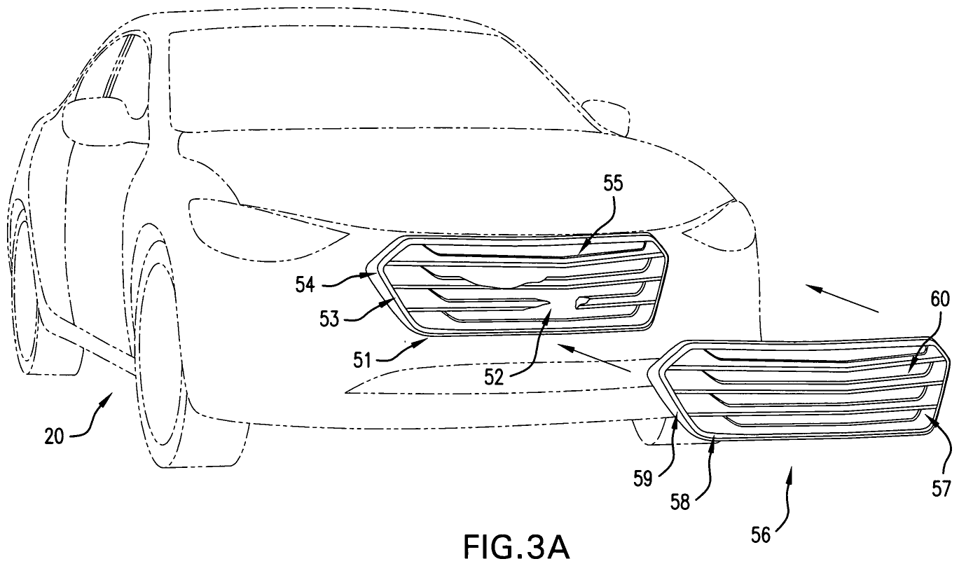

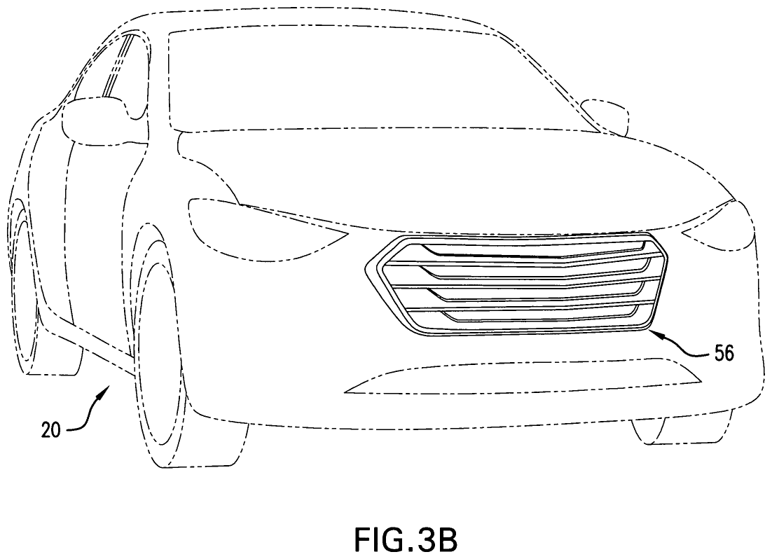

Still referring to the embodiment of this present invention, FIG. 3A illustrates an automobile 20 with a damaged manufacturer's grilled 51 which comprises a damaged inner representative horizontal slat 52, a smaller-inner and peripheral-hexagonal member 53 and a larger-outer and peripheral-hexagonal member 54, which in combination form an interlocking grille system with multiple parabolic openings represented as 55. Still referring to FIG. 3A, a pre-installed automotive grille overlay of the present invention 56 comprises multiple, undamaged inner horizontal slats represented as 57, a smaller-inner and peripheral-hexagonal member 58 and a larger-outer and peripheral-hexagonal member 59, which in combination form an interlocking grille system of the present invention with multiple parabolic openings represented as 60. As shown in FIG. 3B, an automotive grille overlay 56 of the present invention with identical configuration of said damaged manufacturer's automotive grille 51 is securely snapped on into place over the latter, thereby providing the appearance of a new or enhance manufacturer's automotive grille without the need of removing said damaged manufacturer's automotive grille 51.

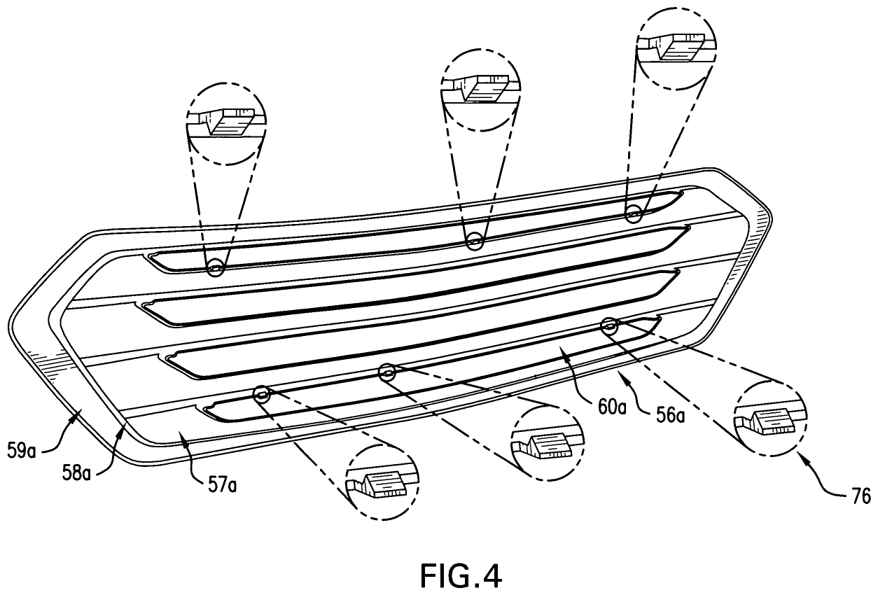

Yet again referring to the embodiment of this present invention, FIG. 4 illustrates a rear elevated perspective view of the improved snap-on automotive grille overlay of the present invention 56a which comprises a rear view of multiple inner horizontal slats represented as 57a, a rear view of a smaller-inner and peripheral-hexagonal member 58a and a rear view of a larger-outer and peripheral-hexagonal member 59a, which in combination form an interlocking grille system of the present invention, with multiple parabolic openings represented as 60a. As shown in FIG. 4 are clips represented as 76 which may or may not be used in conjunction with the hook-shaped members of the present invention to affix the automotive grille of the present invention over an existing manufacturer's automotive grille.

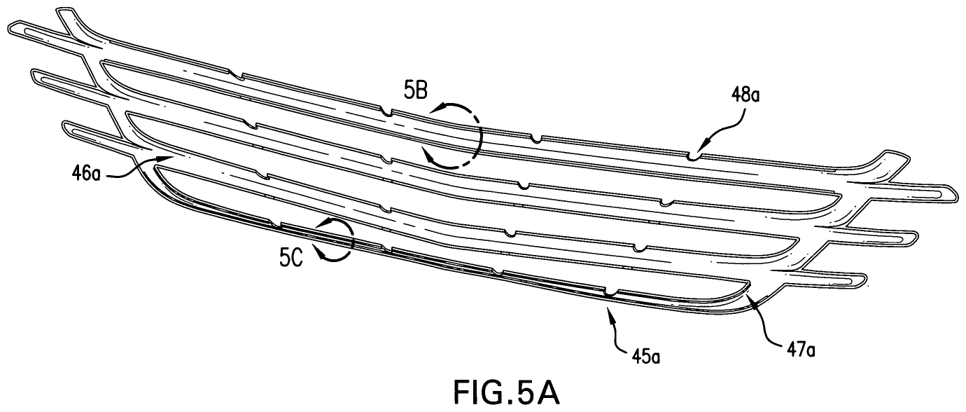

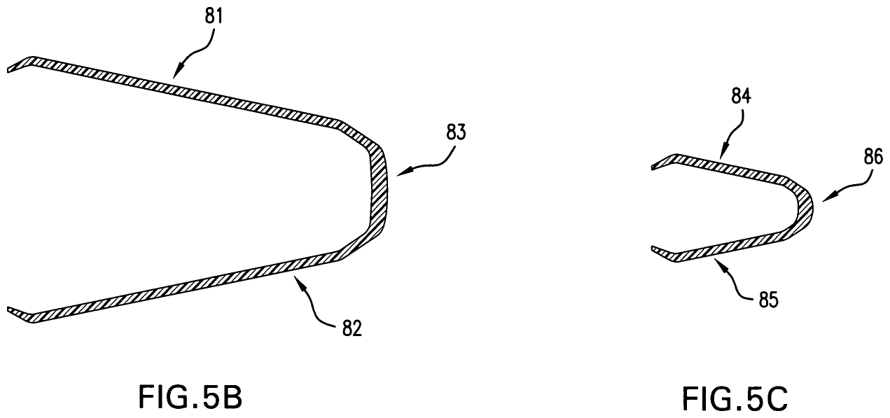

Still referring to the embodiment of this present invention, FIG. 5A illustrates a rear elevation view of the improved snap-on automotive grille overlay of the present invention 45a which comprises a rear view of multiple inner horizontal slats represented as 46a, a rear view of an outer peripheral-vertical parabolic bar 47a and a rear view of a sample groove 48a used for attaching said grille over a damaged manufacturer's grille with clips or other fasters, etc. FIG. 5B is a cross-sectional view taken along a section of FIG. 5A illustrating a polymer hook-shaped member of the snap-on technology unique to the present invention.

Specifically referring to the cross sectional area of FIG. 5B, the interior regions of a horizontal slat 46a of the present invention's improved automotive grille overlay containing the snap-on technology used for snapping over a corresponding horizontal slat of a damaged manufacturer's existing grille comprises a rigid polymer upper lip 81 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the horizontal slat 46a of the present invention's automotive grille overlay containing the snap-on technology used for snapping over a corresponding horizontal slat of a damaged manufacturer's existing grille there is a corresponding rigid polymer lower lip 82 protruding continuously along a rigid polymer lower longitudinal edge and a rigid polymer lower arm edge which is capable of having a curved shape, an oval shape, a linear shape or having a polygon shape with respect to the lower longitudinal edge. That along the interior regions of a horizontal slat 46a, the interior regions of the upper lip 81 and the interior regions of the lower lip 82 are connected by an interior region 83 formed at the tip end of each and every horizontal slat as shown in FIG. 5A. The connecting interior region 83 is capable of having a curved shape, an oval shape, a parabolic shape, a linear shape, a polygon shape or having any shape to accommodate said horizontal slats upper and lower interior regions design 81 and 82 respectively of the automotive grille of the present invention. All the interior regions are elongated and are composed of rigid polymer materials.

Specifically referring to the cross sectional area of FIG. 5C, the interior region of the outer peripheral-vertical parabolic bar 47a of the present invention's improved automotive grille overlay containing the snap-on technology used for snapping over a corresponding peripheral-vertical parabolic bar of a damaged manufacturer's existing grille comprises a rigid polymer upper lip 84 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the outer peripheral-vertical parabolic bar 47a of the present invention's improved automotive grille overlay containing the snap-on technology is used for snapping over a corresponding horizontal slat of a damaged manufacturer's existing grille. In addition, there is a corresponding rigid polymer lower lip 85 protruding continuously along a rigid polymer lower longitudinal edge and a rigid polymer lower arm edge which is capable of having a curved shape, an oval shape, a linear shape or having a polygon shape with respect to the lower longitudinal edge. That along the interior regions of the outer peripheral-vertical parabolic bar 47a, the interior regions of the upper lip 84 and the interior regions of the lower lip 85 are connected by an interior region 86 formed at the tip ends of the outer-vertical parabolic bar 47a as shown in FIG. 5A. The connecting interior region 86 is capable of having a curved shape, an oval shape, a parabolic shape, a linear shape, a polygon shape or having any shape to accommodate said outer-vertical parabolic bar's upper and lower interior regions design 84 and 85 respectively of the improved automotive grille of the present invention.

During installation of the improved automotive grille of the present invention, the rear surfaces and interior regions of the grille overlay as depicted in FIG. 5A, FIG. 5B and FIG. 5C respectively containing the snap-on technology used for snapping over corresponding regions of a damaged manufacturer's existing grille is comprised of an upper rigid polymer hook-shaped member that protrudes along the entire upper lip and defines and interior region which grippingly engages an upper portion of an existing damaged manufacturer's grille, a lower rigid polymer hook-shaped member that protrudes along the entire lower lip and defines and interior region which grippingly engages a lower portion of an existing, damaged manufacturer's grille, and a connecting rigid polymer hook-shaped member (which connects the upper rigid polymer hook-shaped member to the lower rigid polymer hook-shaped member) that protrudes along the entire connecting lip and defines an interior region which grippingly engages a connecting portion of an existing, damaged manufacturer's grille when installed.

As such after installation, the interior regions of the present invention's improved automotive grille overlay containing the snap-on technology is used for snapping over corresponding regions of a manufacturer's damaged existing grille, wherein upon engagement of said rigid polymer upper lip and said rigid polymer lower lip and said connecting rigid polymer lip of the present invention's improved automotive grille overlay with the corresponding portions of a damaged existing manufacturer's grille, the present invention's improved automotive grille overlay is firmly affixed to said manufacturer's grille leaving no room for vibrations or interplay when an automobile is in motion.

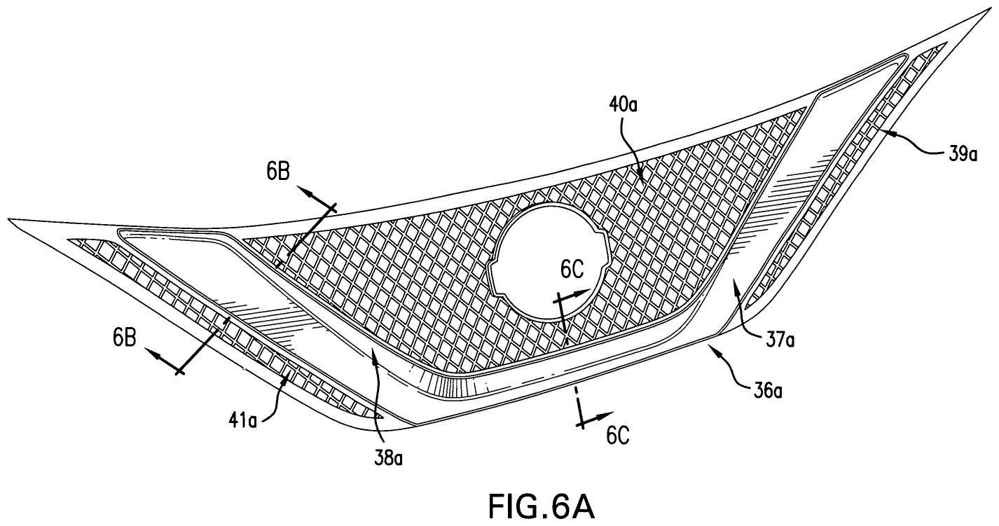

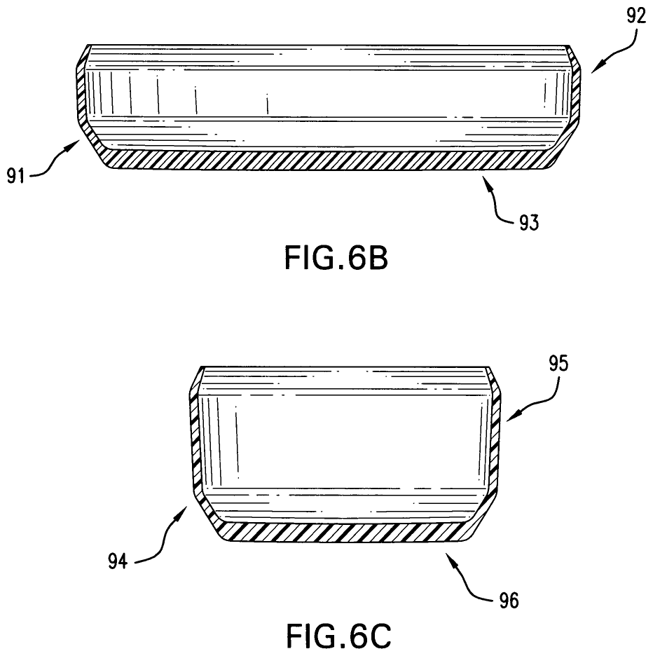

Yet still, referring to FIG. 6A of the present invention is a rear elevated perspective view of the improved snap-on automotive grille overlay 36a which comprises the rear surface of a larger-outer parabolic bar 37a, the rear surface of a smaller-inner parabolic bar 38a, the rear surface of an outer peripheral parabolic bar 39a, the rear surface of a major polygon-based interlocking mesh system 40a, and the rear surface of a minor polygon-based interlocking mesh system 41a.

Specifically referring to the cross sectional area of FIG. 6B, the interior regions of the slanted vertical portion of the larger-outer parabolic bar 37a of the present invention's automotive improved grille overlay containing the snap-on technology used for snapping over a corresponding slanted vertical portion of the larger-outer parabolic bar of a damaged manufacturer's existing grille comprises a rigid polymer upper lip 91 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the vertical portion of the larger-outer parabolic bar 37a of the present invention's improved automotive grille overlay containing the snap-on technology used for snapping over a corresponding larger-outer parabolic bar of a damaged manufacturer's existing grille, there is a corresponding rigid polymer opposite lower lip 92 protruding continuously along a rigid polymer lower longitudinal edge and a rigid polymer lower arm edge which is capable of having a curved shape, an oval shape, a linear shape or having a polygon shape with respect to the lower longitudinal edge. That along the interior regions of the vertical portion of the larger-outer parabolic bar 37a, the interior regions of the upper lip 91 and the interior regions of the lower lip 92 are connected by an interior region 93 as shown in FIG. 6A and FIG. 6B. The continuous connecting interior region 93 is capable of having a curved shape, an oval shape, a parabolic shape, a linear shape, a polygon shape or having any shape to accommodate said rear vertical portion of the larger-outer parabolic bar's upper and lower interior regions design 91 and 92 respectively of the improved automotive grille of the present invention.

Specifically referring to the cross sectional area of FIG. 6C, the interior regions of the rear surface of the horizontal portion of the larger-outer parabolic bar 37a of the present invention's improved automotive grille overlay containing the snap-on technology used for snapping over a corresponding vertical portion of the front surface of the horizontal portion of the larger-outer parabolic bar of a damaged manufacturer's existing grille comprises a rigid polymer upper lip 94 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the rear surface of the horizontal portion of the larger-outer parabolic bar 37a of the present invention's improved automotive grille overlay containing the snap-on technology used for snapping over a corresponding horizontal portion of the larger-outer parabolic bar 37a of a damaged manufacturer's existing grille, there is a corresponding rigid polymer opposite lower lip 95 protruding continuously along a rigid polymer lower longitudinal edge and a rigid polymer lower arm edge which is capable of having a curved shape, an oval shape, a linear shape or having a polygon shape with respect to the lower longitudinal edge. That along the interior regions of the horizontal portion of the larger-outer parabolic bar 37a, the interior regions of the upper lip 94 and the interior regions of the lower lip 95 are connected by an interior region 96 as shown in FIG. 6A and FIG. 6C. The continuous connecting interior region 96 is capable of having a curved shape, an oval shape, a parabolic shape, a linear shape, a polygon shape or having any shape to accommodate said rear vertical portion of the larger-outer parabolic bar's upper and lower interior regions design 94 and 95 respectively of the improved. automotive grille of the present invention. All the interior regions are elongated and are composed of rigid polymer materials.

During installation of the improved automotive grille of the present invention, the rear surfaces and interior regions of the grille overlay as depicted in FIG. 6A, FIG. 6B and FIG. 6C respectively containing the snap-on technology used for snapping over corresponding regions of a damaged manufacturer's existing grille is comprised of an upper rigid polymer hook-shaped member that protrudes along the entire upper lip and defines and interior region which grippingly engages an upper portion of an existing damaged manufacturer's grille, a lower rigid polymer hook-shaped member that protrudes along the entire lower lip and defines and interior region which grippingly engages a lower portion of an existing, damaged manufacturer's grille, and a connecting rigid polymer hook-shaped member (which connects the upper rigid polymer hook-shaped member to the lower rigid polymer hook-shaped member) that protrudes along the entire connecting lip and defines an interior region which grippingly engages a connecting portion of an existing, damaged manufacturer's grille when installed.

As such after installation, the interior regions of the present invention's improved automotive grille overlay containing the snap-on technology is used for snapping over corresponding regions of a manufacturer's damaged existing grille, wherein upon engagement of said rigid polymer upper lip and said rigid polymer lower lip and said connecting rigid polymer lip of the present invention's improved automotive grille overlay with the corresponding portions of a damaged existing manufacturer's grille, the present invention's improved automotive grille overlay is firmly affixed to said manufacturer's grille leaving no room for vibrations or interplay when an automobile is in motion.

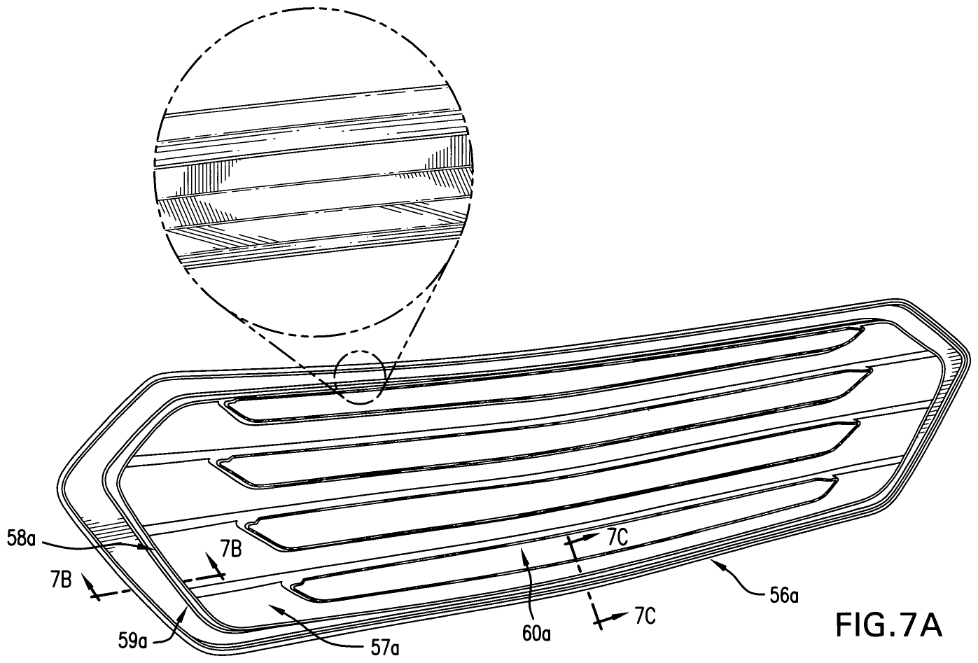

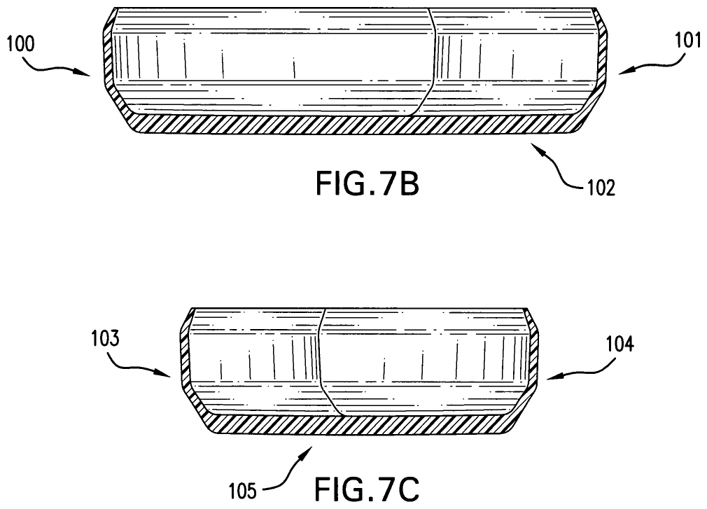

Still, referring to the embodiment of this present invention, FIG. 7A illustrates a rear elevated perspective view of the improved snap-on automotive grille overlay 56a which comprises a rear view of multiple inner horizontal slats represented as 57a, a rear view of a smaller-inner and peripheral-hexagonal member 58a and a rear view of a larger-outer and peripheral-hexagonal member 59a, which in combination form an interlocking grille system of the present invention, with multiple parabolic openings represented as 60a.

Specifically referring to the cross sectional area of FIG. 7B, the interior regions of the larger outer and peripheral-hexagonal member portion 59a of the rear elevated perspective view of the improved snap-on automotive grille overlay of the present invention containing the snap-on technology used for snapping over a corresponding front portion of the larger outer and peripheral-hexagonal member portion of a damaged manufacturer's existing grille, which comprises a rigid polymer upper lip 100 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the larger outer and peripheral-hexagonal member portion 59a of the present invention's improved automotive grille overlay containing the snap-on technology used for snapping over a corresponding larger-outer and peripheral-hexagonal member front portion of a damaged manufacturer's existing grille there is a corresponding rigid polymer opposite lower lip 101 protruding continuously along a rigid polymer lower longitudinal edge and a rigid polymer lower arm edge which is capable of having a curved shape, an oval shape, a linear shape or having a polygon shape with respect to the lower longitudinal edge. That along the interior regions of the larger outer and peripheral-hexagonal member portion 59a of the rear elevated perspective view of the improved snap-on automotive grille overlay, the interior regions of the upper lip 100 and the interior regions of the lower lip 101 are connected by an interior region 102 as shown in FIG. 7A and FIG. 7B. The continuous connecting interior region 102 is capable of having a curved shape, an oval shape, a parabolic shape, a linear shape, a polygon shape or having any shape to accommodate said rear portion of the larger-outer and peripheral hexagonal member's upper and lower interior regions design 101 and 102 respectively of the improved automotive grille of the present invention. All the interior regions are elongated and are composed of rigid polymer material.

Specifically referring to the cross sectional area of FIG. 7C, the interior regions of the rear surface of the smaller-inner and peripheral-hexagonal member 58a of the present invention's improved automotive grille overlay containing the snap-on technology used for snapping over a corresponding front surface of the smaller-inner and peripheral-hexagonal member of a damaged manufacturer's existing grille which comprises a rigid polymer upper lip 103 protruding continuously along a rigid polymer upper longitudinal edge and a rigid polymer upper arm edge which is capable of having a curved shape, an oval shape, a parabolic shape, a linear shape or a polygon shape with respect to the upper longitudinal edge. Still referring to the interior regions of the rear surface of the smaller-inner and peripheral-hexagonal member 58a of the present invention's improved automotive grille overlay containing the snap-on technology used for snapping over a corresponding smaller-inner and peripheral-hexagonal front portion of a damaged manufacturer's existing grille, there is a corresponding rigid polymer opposite lower lip 104 protruding continuously along a rigid polymer lower longitudinal edge and a rigid polymer lower arm edge which is capable of having a curved shape, an oval shape, a linear shape or having a polygon shape with respect to the lower longitudinal edge.

That along the interior regions of the of the rear surface of the smaller-inner and peripheral-hexagonal member 58a of the present invention's, the interior regions of the upper lip 103 and the interior regions of the lower lip 104 are connected by an interior region 105 as shown in FIG. 7A and FIG. 7C. The continuous connecting interior region 105 is capable of having a curved shape, an oval shape, a parabolic shape, a linear shape, a polygon shape or having any shape to accommodate said rear surface of the smaller-inner and peripheral-hexagonal member 58a of the present invention's upper and lower interior regions design 103 and 104 respectively of the improved automotive grille of the present invention.

During installation of the improved automotive grille of the present invention, the rear surfaces and interior regions of the grille overlay as depicted in FIG. 7A, FIG. 7B and FIG. 7C respectively containing the snap-on technology used for snapping over corresponding regions of a damaged manufacturer's existing grille is comprised of an upper rigid polymer hook-shaped member that protrudes along the entire upper lip and defines and interior region which grippingly engages an upper portion of an existing damaged manufacturer's grille, a lower rigid polymer hook-shaped member that protrudes along the entire lower lip and defines and interior region which grippingly engages a lower portion of an existing, damaged manufacturer's grille, and a connecting rigid polymer hook-shaped member (which connects the upper rigid polymer hook-shaped member to the lower rigid polymer hook-shaped member) that protrudes along the entire connecting lip and defines an interior region which grippingly engages a connecting portion of an existing, damaged manufacturer's grille when installed.

As such after installation, the interior regions of the present invention's improved automotive grille overlay containing the snap-on technology is used for snapping over corresponding regions of a manufacturer's damaged existing grille, wherein upon engagement of said rigid polymer upper lip and said rigid polymer lower lip and said connecting rigid polymer lip of the present invention's improved automotive grille overlay with the corresponding portions of a damaged existing manufacturer's grille, the present invention's improved automotive grille overlay is firmly affixed to said manufacturer's grille leaving no room for vibrations or interplay when an automobile is in motion.

That to produce the finished embodiment described in the specification, suitable polymer materials well known in the art are first selected and tested for strength, durability, malleability and resistance, etc. to meet after-market standards and particularly to meet the rigid original equipment manufacturer (OEM) standards demanded by established automobile manufacturers and distributors. Suitable rigid polymer materials are used straightly and without mixing or proportionally in percentile combination with other polymer materials, including but not limited to, polypropylene, polystyrene, polyethylene, poly vinyl chloride, and acrylonitrile butadeine styrene.

First, these materials (prior to being chrome plated and after being chrome plated) are placed through thermal cycle test(s) and exposed to predetermined temperature to examine for dimensional changes, deformation, clearance gaps, waviness, unevenness, creases, split, crack, breakage, blister, peeling and discoloration, etc. Second, these materials (prior to being chrome plated and after being chrome plated) are placed through chemical resistance test(s) and exposed to predetermined chemical concentrations, such as artificial perspiration, detergent, insect repellent, sun tan oil, sun screening cream and liquid paraffin, etc. to examine for dissolving, cloudiness, stains, discoloration, deformation, uneven surfaces, blooming, sticky surfaces, contamination, glossiness, cracking, breakage, softening, hardening, swelling, thinning and shrinkage, etc. Third, these materials (prior to being chrome plated and after being chrome plated) are placed falling ball impact test(s) by dropping a steel ball from a predetermined height to examine for cracks, breakage, detrimental deformation on the materials visible surface, and for conforming, etc. Fourth, these materials (prior to being chrome plated and after being chrome plated) are placed through pencil scratch test(s) and exposed to predetermined variable models of pencils, so as to examine for surface hardness and scratch resistance, etc. Fifth, these materials (prior to being chrome plated and after being chrome plated) are placed through abrasion resistance test(s) or TABER and exposed to predetermined abrasion wheels, load and rotation speed, etc. so as to examine for glossiness before gloss, after gloss and overall gloss retention. Sixth, these materials (prior to being chrome plated and after being chrome plated) are placed through scratch resistance test(s) and exposed to predetermined load, scratching speed and scratch length using sand paper, glass bead and abrasion tester to examine for based surface exposure, flaw observation rank and the difference between gloss value after test and initial gloss value.

After the suitable materials are selected and tested as describe above, a three dimensional (3D) scanned imaging of the individual embodiment component parts are generated. Next, the three dimensional scanned imaging of said individual embodiment component parts are transferred to an injection molding computer to generate the injection molding designed precisely corresponding to each individual component parts of the three embodiments of the present invention. Next, the desired material (preferably, but not limited to, rigid polymer material) is placed in the injection molding to form the individual component parts. After the individual component parts are formed from the injection molding, a fine tuning/finishing process ensues where the component parts are smoothed to remove all/any sharp and/or rough edges. Finally, the individual component parts of the present invention are chromed to obtain the final product.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter. The snap-on technology of this present invention with variation and unique contours can be used for other car accessories such as wheels, view mirrors, side mirrors, license plate covers, etc. These accessories are capable of being fitted with LEDs as deemed necessary and appropriate and consistent with various regulations.

Those skilled in the art will readily appreciate that various modifications and changes can be applied to the embodiment of the invention as herein before described without departing from its scope, defined in and by the appended claims.

What is claimed is:

1. An improved snap-on automotive grille overlay is contoured to precisely form to the visible surface of an existing manufacturer's grille (damaged or undamaged) such that upon engagement said improved automotive grille overlay of the present invention is neatly snapped-on and intended to be flushed against the manufacturer's automotive grille with the optional use of clips and tapes, and comprising:
a. at least one large parabolic bar;
b. at least one small parabolic bar;
c. at least one minor interlocking mesh system;
d. at least one major interlocking mesh system;
e. an oval opening;
f. at least one peripheral boundary member;
g. at least one horizontal slat;
h. at least one groove;
i. at least one parabolic opening; and
j. an elongate interior region composed of rigid polymer material

2. The improved snap-on automotive grille overlay of claim 1 comprising an elongate interior region composed of rigid polymer material having:
a. a rigid polymer upper lip protruding continuously along a rigid polymer upper longitudinal edge and a rigid polymer arm edge which is curved with respect to the upper longitudinal edge;
b. a rigid polymer lower lip protruding continuously along a rigid polymer lower longitudinal edge and a rigid polymer lower arm edge which is curved with respect to the lower longitudinal edge;
c. an upper rigid polymer hook-shaped member that protrudes along the entire upper lip and defines an interior region which grippingly engages an upper portion of a manufacturer's automobile grille;
d. a lower rigid polymer hook-shaped member that protrudes along the entire lower lip and defines an interior region which grippingly engages a lower portion of the a manufacturer's automobile door handle; wherein upon engagement of said polymer upper lip and said rigid polymer lower lip on the manufacturer's automotive grille the improved snap-on automotive grille overlay of the present invention is thereby firmly affixed to the manufacturer's grille.

3. The improved snap-on automotive grille overlay of claim 2, wherein said rigid polymer upper lip curves along the upper longitudinal edge to form an interior region.

4. The improved snap-on automotive grille overlay of claim 3, wherein said rigid polymer lower lip curves along the lower longitudinal edge to form an interior region,

5. The improved snap-on automotive grille overlay of claim 4, wherein said interior region formed by the curved upper lip along the upper longitudinal edge and said interior region formed by the curved lower lip along the lower longitudinal edge are connected by a continuous curved interior region.

6. The improved snap-on automotive grille overlay of claim 5 comprising an upper rigid polymer hook-shaped member that protrudes along the entire upper lip and defines and interior region which grippingly engages an upper portion of an existing damaged manufacturer's grille, a lower rigid polymer hook-shaped member that protrudes along the entire lower lip and defines an interior region which grippingly engages a lower portion of an existing, damaged manufacturer's grille, a connecting rigid polymer hook-shaped member, which connects the upper rigid polymer hook-shaped member to the lower rigid polymer hook-shaped member, wherein said connecting rigid polymer hook-shaped member protrudes along the entire connecting lip and defines an interior region which grippingly engages a connecting portion of an existing, damaged manufacturer's grille when installed.

7. The improved snap-on automotive grille overlay of claim 6, wherein a front surface of the improved snap-on automotive grille overlay of the present invention is finished in a decorative finish.

8. The improved snap-on automotive grille overlay of claim 7, wherein said large parabolic bar is an outer parabolic bar.

9. The improved snap-on automotive grille overlay of claim 8, wherein said small parabolic bar in an inner parabolic bar.

10. The improved snap-on automotive grille overlay of claim 9, wherein said interlocking mesh system is polygon-based.

11. The improved snap-on automotive grille overlay of claim 7, wherein said large parabolic bar is an outer peripheral-vertical parabolic bar.

12. The improved snap-on automotive grille overlay of claim 7, wherein said small parabolic bar is an outer peripheral-vertical parabolic bar.

13. The improved snap-on automotive grille overlay of claim 7, wherein said groove is along the horizontal slat.

14. The improved snap-on automotive grille overlay of claim 13, wherein said peripheral boundary member is a smaller-inner hexagonal member.

15. The improved snap-on automotive grille overlay of claim 13, wherein said peripheral boundary member is a larger-outer hexagonal member.

16. An improved snap-on automotive grille overlay is contoured to precisely form to the visible surface of an existing manufacturer's grille (damaged or undamaged) such that upon engagement said improved automotive grille overlay of the present invention is neatly snapped-on and intended to be flushed against the manufacturer's automotive grille with the optional use of clips and tapes, and comprising of at least one large parabolic bar, at least one small parabolic bar, at least on minor interlocking mesh system, at least one major interlocking mesh system, an oval opening; at least one peripheral boundary member, at least one horizontal slat, at least one groove, at least one parabolic opening, and an elongate interior region composed of rigid polymer material, and said improved automotive grille overlay is manufactured by a process comprising the steps of:
i. selecting suitable polymer materials;
ii. performing thermal cycle testing of said suitable polymer materials;
iii. performing chemical resisting testing of said suitable polymer materials;
iv. performing falling ball impact testing of said suitable polymer materials;
v. performing pencil scratching testing of said suitable polymer materials;
vi. performing abrasion resistance testing of said suitable polymer materials;
vii. performing scratch resistance testing of said suitable polymer materials;
viii. providing a three dimensional scanned imaging of individual component parts;
ix. transferring said three dimensional scanned imaging of said individual component parts to an injection molding computer to generate precise corresponding design of said component parts;
x. placing rigid polymer material, in an injection molding to form said individual component parts;
xi. finishing said component parts by smoothing said parts and removing all sharp and rough edges; and
xii. chroming said component parts.

17. The improved snap-on automotive grille overlay of claim 16 comprising an elongate interior region composed of rigid polymer material having:
a. having a rigid polymer upper lip protruding continuously along a rigid polymer upper longitudinal edge and a rigid polymer arm edge which is curved with respect to the upper longitudinal edge a rigid polymer upper lip protruding continuously along a rigid polymer upper longitudinal edge and a rigid polymer arm edge which is curved with respect to the upper longitudinal edge;
b. a rigid polymer lower lip protruding continuously along a rigid polymer lower longitudinal edge and a rigid polymer lower arm edge which is curved with respect to the lower longitudinal edge an upper rigid polymer hook-shaped member that protrudes along the entire upper lip and defines an interior region which grippingly engages an upper portion of a manufacturer's automobile grille;
c. an upper rigid polymer hook-shaped member that protrudes along the entire upper lip and defines an interior region which grippingly engages an upper portion of a manufacturer's automobile grille;
d. a lower rigid polymer hook-shaped member that protrudes along the entire lower lip and defines an interior region which grippingly engages a lower portion of the a manufacturer's automobile door handle, wherein upon engagement of said polymer upper lip and said rigid polymer lower lip on the manufacturer's automotive grille the improved snap-on automotive grille overlay of the present invention is thereby firmly affixed to the manufacturer's grille.

18. The improved snap-on automotive grille overlay of claim 17, wherein said rigid polymer upper lip curves along the upper longitudinal edge to form an interior region.

19. The improved snap-on automotive grille overlay of claim 18, wherein said rigid polymer lower lip curves along the lower longitudinal edge to form an interior region,

20. The improved snap-on automotive grille overlay of claim 19, wherein said interior region formed by the curved upper lip along the upper longitudinal edge and said interior region formed by the curved lower lip along the lower longitudinal edge are connected by a continuous curved interior region.

21. The improved snap-on automotive grille overlay of claim 20 comprising an upper rigid polymer hook-shaped member that protrudes along the entire upper lip and defines and interior region which grippingly engages an upper portion of an existing damaged manufacturer's grille, a lower rigid polymer hook-shaped member that protrudes along the entire lower lip and defines an interior region which grippingly engages a lower portion of an existing, damaged manufacturer's grille, a connecting rigid polymer hook-shaped member, which connects the upper rigid polymer hook-shaped member to the lower rigid polymer hook-shaped member, wherein said connecting rigid polymer hook-shaped member protrudes along the entire connecting lip and defines an interior region which grippingly engages a connecting portion of an existing, damaged manufacturer's grille when installed.

22. The improved snap-on automotive grille overlay of claim 21, wherein a front surface of the improved snap-on automotive grille overlay of the present invention is finished in a decorative finish.

23. The improved snap-on automotive grille overlay of claim 22, wherein said large parabolic bar is an outer parabolic bar.

24. The improved snap-on automotive grille overlay of claim 23, wherein said small parabolic bar in an inner parabolic bar.

25. The improved snap-on automotive grille overlay of claim 24, wherein said interlocking mesh system is polygon-based.

26. The improved snap-on automotive grille overlay of claim 25, wherein said large parabolic bar is an outer peripheral-vertical parabolic bar.

27. The improved snap-on automotive grille overlay of claim 26, wherein said small parabolic bar is an outer peripheral-vertical parabolic bar.

28. The improved snap-on automotive grille overlay of claim 27, wherein said groove is along the horizontal slat.

29. The improved snap-on automotive grille overlay of claim 28, wherein said peripheral boundary member is a smaller-inner hexagonal member.

30. The improved snap-on automotive grille overlay of claim 29, wherein said peripheral boundary member is a larger-outer hexagonal member.
